(19) United States
(12) Patent Application Publication
(10) Pub. No.: US 2024/0395144 A1
(43) Pub. Date: Nov. 28, 2024

(54) INFORMATION PROCESSING METHOD, NON-TRANSITORY STORAGE MEDIUM, AND INFORMATION PROCESSING DEVICE

(71) Applicant: TOYOTA JIDOSHA KABUSHIKI KAISHA, Toyota-shi (JP)

(72) Inventors: Jing MA, Yokohama-shi (JP); Naoya KANEKO, Tokyo (JP); Xiao SHAO, Kawasaki-shi (JP); Kazuya OKADA, Tokyo (JP); Takuya ASAOKA, Tokyo (JP)

(73) Assignee: TOYOTA JIDOSHA KABUSHIKI KAISHA, Toyota-shi, Aichi-ken (JP)

(21) Appl. No.: 18/631,718

(22) Filed: Apr. 10, 2024

(30) Foreign Application Priority Data
May 25, 2023 (JP) 2023-086201

(51) Int. Cl. G08G 1/14

(52) U.S. Cl. CPC G08G 1/143

(57) ABSTRACT

A first vehicle acquires first data about the vacancy status of a first parking lot when exiting from the first parking lot, broadcasts second data including an identifier of the first parking lot, and transmits, in response to a request transmitted from a second vehicle having received the second data, the first data to the second vehicle.

### CROSS-REFERENCE TO RELATED APPLICATION

This application claims priority to Japanese Patent Application No. 2023-086201 filed on May 25, 2023, incorporated herein by reference in its entirety.

### BACKGROUND

### 1. Technical Field

The present disclosure relates to a technique of providing information about a parking lot.

### 2. Description of Related Art

A system that collects and manages the vacancy status of a parking lot is known. Japanese Unexamined Patent Application Publication No. 2002-203300 (JP 2002-203300 A), for example, discloses a device that collects and accumulates data about the vacancy status of a plurality of parking lots and provides such data via the Internet. No. 2008-077444 (JP 2008-077444 A) discloses related art.

### SUMMARY

The present disclosure has an object to share the vacancy status of a parking lot among a plurality of vehicles.

An aspect of an embodiment of the present disclosure provides an information processing method including: acquiring first data about a vacancy status of a first parking lot by a first vehicle when exiting from the first parking lot; broadcasting second data including an identifier of the first parking lot by the first vehicle having exited from the first parking lot; and transmitting, in response to a request transmitted from a second vehicle having received the second data, the first data to the second vehicle by the first vehicle.

In the information processing method described above, the second vehicle may determine whether to request the first vehicle to transmit the first data based on at least the identifier of the parking lot included in the second data.

In the information processing method described above, the second vehicle may request the first vehicle to transmit the first data when the first parking lot meets a predetermined condition.

In the information processing method described above, the predetermined condition may be met when the second vehicle does not have information about the vacancy status of the first parking lot.

In the information processing method described above, the predetermined condition may be met when the second vehicle does not have information about the vacancy status of the first parking lot generated after a predetermined timing.

In the information processing method described above, the first data may include a map that indicates the vacancy status of the first parking lot.

In the information processing method described above, the second vehicle may perform parking control for the vehicle based on the first data received from the first vehicle.

In the information processing method described above, the second vehicle may provide a driver with guidance on a parking compartment based on the first data received from the first vehicle.

In the information processing method described above, the first vehicle may broadcast the second data at predetermined time intervals until a predetermined period elapses after the first vehicle exits from the first parking lot.

In the information processing method described above, the predetermined period may be determined based on a distance traveled by the first vehicle after exiting from the first parking lot.

In the information processing method described above, the predetermined period may be determined based on an elapsed time since the first vehicle exits from the first parking lot.

An aspect of an embodiment of the present disclosure provides an information processing device associated with a first vehicle, including a control unit configured to: acquire first data about a vacancy status of a first parking lot when the first vehicle exits from the first parking lot; broadcast second data including an identifier of the first parking lot via a communication device mounted on the first vehicle; and transmit, in response to a request transmitted from a second vehicle having received the second data, the first data to the second vehicle.

In the information processing device described above, the control unit may be configured to receive the first data from a server device associated with the first parking lot.

In the information processing device described above, the first data may include a map that indicates the vacancy status of the first parking lot.

In the information processing device described above, the control unit may be configured to broadcast the second data at predetermined time intervals until a predetermined period elapses after the first vehicle exits from the first parking lot.

In the information processing device described above, the predetermined period may be determined based on a distance traveled by the first vehicle after exiting from the first parking lot.

In the information processing device described above, the predetermined period may be determined based on an elapsed time since the first vehicle exits from the first parking lot.

Another aspect provides a non-transitory storage medium storing a program causing a computer to execute the method described above (a computer-readable storage medium storing such a program in a non-transitory manner).

According to the present disclosure, it is possible to share the vacancy status of a parking lot among a plurality of vehicles.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 illustrates constituent elements of a vehicle system according to an embodiment;

FIG. 2 illustrates the hardware configuration of a vehicle 1;

FIG. 3 illustrates the hardware configuration of a parking lot server 2;

FIG. 4 illustrates the software configuration of an in-vehicle device 10;

FIG. 5 illustrates an example of map data stored in the in-vehicle device 10;

FIG. 6 illustrates an example of informing data generated by the in-vehicle device 10;

FIG. 7 illustrates the software configuration of the parking lot server 2;

FIG. 8 is a sequence diagram of processes executed by the constituent elements of the system;

FIG. 9 is a flowchart of a process executed by the parking lot server 2;

FIG. 10 is a flowchart of a process executed by a first vehicle; and

FIG. 11 is a flowchart of a process executed by a second vehicle.

### DETAILED DESCRIPTION OF EMBODIMENTS

There is a service that generates information about the vacancy status of a parking lot using a sensor provided in the parking lot, and that provides such information to a user that desires to enter the parking lot. The user that desires to enter the parking lot can be informed of the vacancy status of the desired parking lot by accessing a server device (e.g. a web server) that provides such a service via the Internet etc., for example.

With the existing technique, however, a driver that desires to obtain information about the vacancy status of a parking lot must access a web service etc. that provides such information beforehand. Even if the information is obtained beforehand, the situation may vary during travel, since the vacancy status of a parking lot varies constantly. That is, the existing technique involves an issue that it is difficult to provide a driver during travel with up-to-date information about the vacancy status of a parking lot.

An information processing method according to an aspect of the present disclosure includes: a first vehicle acquiring first data about a vacancy status of a first parking lot when exiting from the first parking lot; the first vehicle having exited from the first parking lot broadcasting second data including an identifier of the first parking lot; and the first vehicle transmitting, in response to a request transmitted from a second vehicle having received the second data, the first data to the second vehicle.

The first vehicle is a vehicle that has exited from the first parking lot. The first vehicle acquires first data about the vacancy status of the first parking lot when exiting from the parking lot. The first data may be received from a roadside device provided in the parking lot, or may be acquired via a wide area network, for example. The first data may include a map that indicates the vacancy status of the parking lot and a value that represents the number of vehicles that can be parked, for example.

The first vehicle having exited from the parking lot broadcasts second data including the identifier of the parking lot during travel. In other words, the second data can be considered as data for informing nearby vehicles of the first vehicle “possessing information about the vacancy status of the corresponding parking lot”. This allows other vehicles that have received the second data to recognize that the first vehicle possesses information about the vacancy status of the first parking lot.

In response to a request transmitted from a second vehicle having received the second data, the first vehicle transmits the first data to the second vehicle. According to such a configuration, it is possible to share the substantially real-time vacancy status of the parking lot among vehicles.

The first vehicle may broadcast the second data periodically (at predetermined time intervals) until a predetermined period elapses after the first vehicle exits from the first parking lot. The predetermined period may be determined based on the distance traveled by the first vehicle after exiting from the first parking lot, or the elapsed time since the first vehicle exits from the first parking lot, for example. With such a configuration, it is possible to transfer information about the vacancy status to only vehicles positioned in the vicinity of the parking lot while securing the information being up-to-date.

The second vehicle may determine whether to request the first vehicle to transmit the first data based on the identifier of the parking lot included in the second data. For example, the second vehicle may ignore second data including the identifier of a parking lot that have already been received when such second data are received. That is, the second vehicle may request the first vehicle to transmit the first data only when the second vehicle does not have information about the vacancy status of the first parking lot.

The second vehicle may perform parking control for the vehicle in the first parking lot based on the first data received from the first vehicle. The second vehicle may provide a driver with guidance on a parking compartment in the first parking lot based on the first data received from the first vehicle.

Specific embodiments of the present disclosure will be described below with reference to the drawings. The hardware configuration, module configuration, functional configuration, etc. described in relation to the embodiments are not intended to limit the technical scope of the disclosure unless specifically stated otherwise.

### First Embodiment

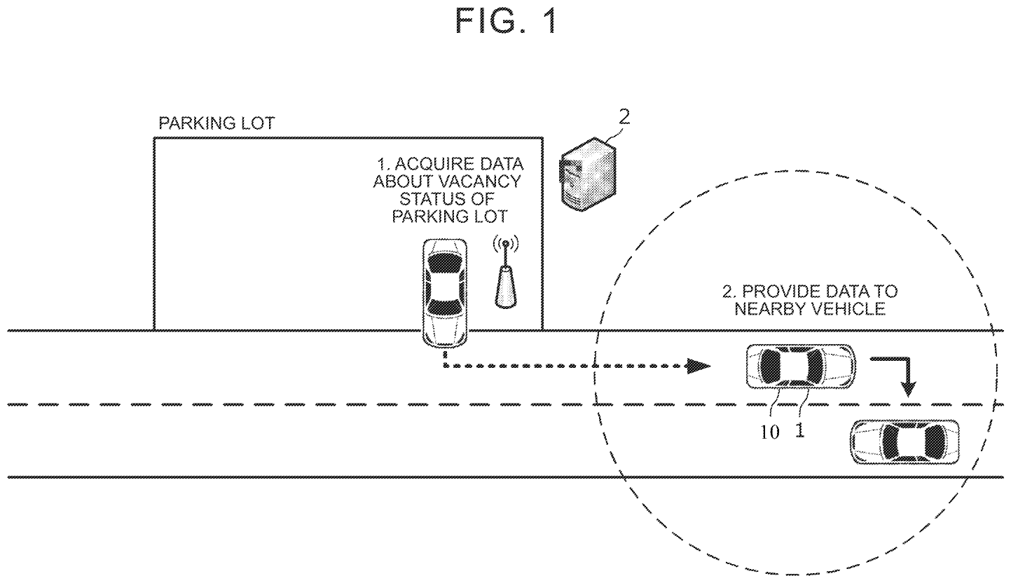

An overview of a vehicle system according to a first embodiment will be described with reference to FIG. 1. The vehicle system according to the present embodiment is configured to include a vehicle 1 on which an in-vehicle device 10 is mounted and a parking lot server 2. The vehicle system may include a plurality of vehicles 1 (and in-vehicle devices 10).

The parking lot server 2 is a server device that manages the vacancy status of a parking lot and that transmits data about the vacancy status of the parking lot to the vehicle 1 exiting from the parking lot. The parking lot server 2 may be provided for each parking lot, or may cover a plurality of parking lots. The parking lot server 2 may be a roadside device provided in a parking lot. The parking lot server 2 may be installed at a location away from a parking lot, and transmit data through a roadside device provided in the parking lot.

The vehicle 1 uses a predetermined parking lot. The vehicle 1 may be an autonomous driving vehicle, or may be a vehicle driven by a driver. The vehicle 1 is configured to execute a process of receiving data about the vacancy status of a parking lot from the parking lot server 2, and a process of exchanging such data among vehicles through vehicle-to-vehicle communication.

In the following description, a vehicle that receives data about the vacancy status of a predetermined parking lot when exiting from the parking lot and that transmits data about the vacancy status of the parking lot to other vehicles through vehicle-to-vehicle communication will be referred to as a “first vehicle”. A vehicle that receives data from the first vehicle through vehicle-to-vehicle communication to grasp the vacancy status of the parking lot will be referred to as a “second vehicle”. In the present embodiment, both the first vehicle and the second vehicle are described as the vehicle 1 with the same constituent elements.

The first vehicle receives data about the vacancy status of a predetermined parking lot from the parking lot server 2 via an antenna provided at an exit, for example, when exiting from the parking lot. In the present embodiment, data about the vacancy status of a parking lot is a map that includes information on the occupancy/vacancy of a plurality of vehicle spaces. Such a map will be referred to as “map data” in the following description. The map data are an example of “first data”.

The first vehicle that has exited from a predetermined parking lot periodically broadcasts data including the identifier of the parking lot in a predetermined period after exiting from the parking lot. The data including the identifier of the parking lot are an example of “second data”. Such data can be considered as data that inform a nearby vehicle (second vehicle) that the first vehicle possesses data about the vacancy status of the corresponding parking lot. Such data will be referred to as “informing data” in the following description.

The second vehicle (e.g. a vehicle that passes the first vehicle) that has received the informing data requests the first vehicle to transmit map data as necessary. For example, the second vehicle requests the first vehicle to transmit map data when the second vehicle does not have data about the vacancy status of the parking lot indicated by the informing data. The first vehicle transmits map data to the second vehicle in response to the request.

Transmission and reception of informing data, request for transmission of map data by the second vehicle, and transmission of map data by the first vehicle may be executed consecutively when the first vehicle and the second vehicle pass each other. This allows the first vehicle to efficiently notify the second vehicle of the vacancy status of a parking lot.

### Hardware Configuration

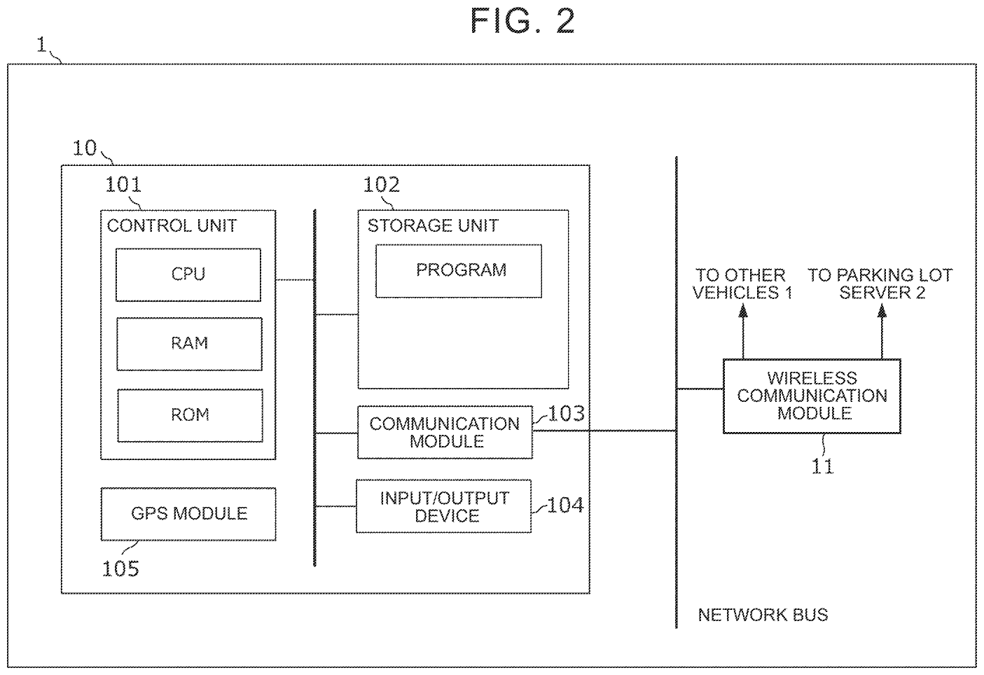

Next, the hardware configuration of devices that constitute the system will be described. FIG. 2 schematically illustrates an example of the hardware configuration of the vehicle 1 and the in-vehicle device 10 according to the present embodiment. The vehicle 1 is configured to include the in-vehicle device 10 and a wireless communication module 11.

The in-vehicle device 10 can be configured as a computer that includes a processor (such as a central processing unit (CPU) and a graphics processing unit (GPU)), a main storage device (such as a random access memory (RAM) and a read only memory (ROM)), and an auxiliary storage device (such as an erasable programmable read only memory (EPROM), a hard disk drive, and a removable medium). The auxiliary storage device stores an operating system (OS), various programs, various tables, etc. Various functions (software modules) that match a predetermined object, to be discussed later, can be implemented by executing a program stored in the auxiliary storage device. However, some or all of the functions may be implemented as hardware modules by a hardware circuit such as an application-specific integrated circuit (ASIC) and a field-programmable gate array (FPGA), for example. The in-vehicle device 10 is connected to a network bus of the vehicle 1.

The wireless communication module 11 is a communication device that performs wireless communication with other devices (or an external network) by way of a network. The wireless communication module 11 functions as a gateway that connects a component of the vehicle 1 to a network that is external to the vehicle. For example, the wireless communication module 11 provides access to an external network to the in-vehicle device 10. This allows the in-vehicle device 10 to communicate with external devices via the wireless communication module 11. The communication method used by the wireless communication module 11 may use a cellular communication network, or may use Dedicated Short-Range Communications (DSRC) or vehicle-to-vehicle communication. The communication method used by the wireless communication module 11 may be a method of performing communication over a relatively short distance that uses Wi-Fi or Bluetooth (registered trademark).

The in-vehicle device 10 will be described in detail. The in-vehicle device 10 is configured to include a control unit 101, a storage unit 102, a communication module 103, an input/output device 104, and a global positioning system (GPS) module 105. The in-vehicle device 10 may be a device (e.g. a car navigation device) that provides information to an occupant of the vehicle.

The control unit 101 is an arithmetic unit that implements various functions of the in-vehicle device 10 by executing a predetermined program. The control unit 101 can be implemented by a hardware processor such as a CPU, for example. The control unit 101 may be configured to include a RAM, a ROM, a cache memory, etc.

The storage unit 102 stores information, and is constituted by a storage medium such as a RAM, a magnetic disk, a flash memory, etc. The storage unit 102 stores a program to be executed by the control unit 101, data to be used by the program, etc.

The communication module 103 is a communication interface that connects the in-vehicle device 10 to an in-vehicle network. The communication module 103 may be configured to include a network interface board that performs communication using a controller area network (CAN) protocol, for example. The in-vehicle device 10 can communicate data with other constituent elements (e.g. an ECU) of the vehicle 1 via the communication module 103.

The input/output device 104 receives an input operation performed by an occupant of the vehicle, and presents information to the occupant. Specifically, the input/output device 104 includes a device for input such as a mouse and a keyboard, and a device for output such as a display and a speaker. The input/output device 104 may be constituted integrally as a touch panel display, for example.

The GPS module 105 includes an antenna that receives a positioning signal transmitted from a positioning satellite (also referred to as a global navigation satellite system (GNSS) satellite), and a module that calculates position information based on the signal received by the antenna.

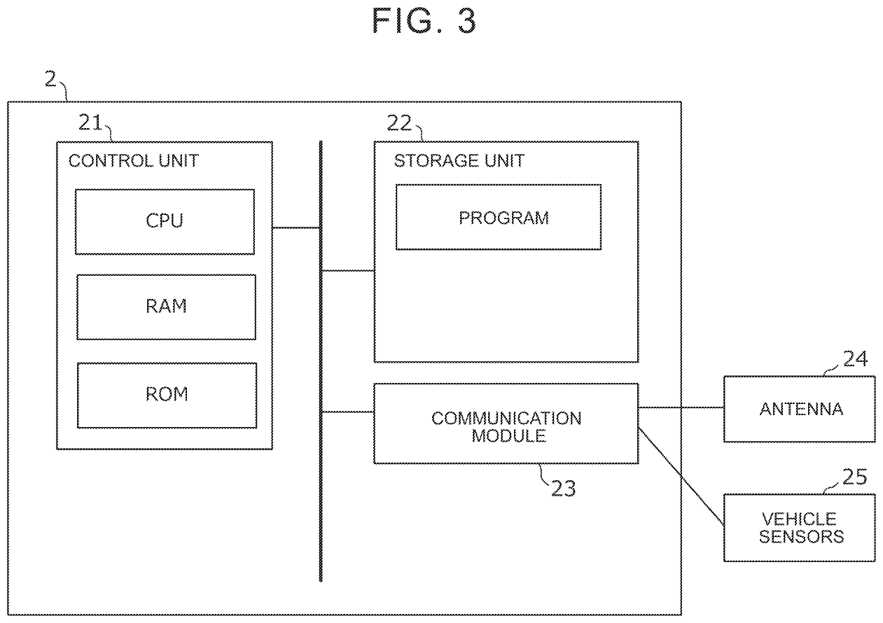

FIG. 3 schematically illustrates an example of the hardware configuration of the parking lot server 2 according to the present embodiment. The parking lot server 2 is constituted as a computer that includes a control unit 21, a storage unit 22, and a communication module 23.

As with the in-vehicle device 10, the parking lot server 2 can be configured as a computer that includes a processor (such as a CPU and a GPU), a main storage device (such as a RAM and a ROM), and an auxiliary storage device (such as an EPROM, a hard disk drive, and a removable medium). However, some or all of the functions (software modules) may be implemented as hardware modules by a hardware circuit such as an ASIC and an FPGA, for example.

The control unit 21 is an arithmetic unit that implements various functions (software modules) of the parking lot server 2 by executing a predetermined program. The control unit 21 can be implemented by a hardware processor such as a CPU, for example. The control unit 21 may be configured to include a RAM, a ROM, a cache memory, etc.

The storage unit 22 stores information, and is constituted by a storage medium such as a RAM, a magnetic disk, a flash memory, etc. The storage unit 22 stores a program to be executed by the control unit 21, data to be used by the program, etc.

The communication module 23 is a communication interface that connects the parking lot server 2 to a network. The communication module 23 may be configured to include a network interface board, a wireless communication interface for wireless communication, etc., for example. The parking lot server 2 can communicate data with other computers via the communication module 23.

Further, the communication module 23 is connected to an antenna 24. The antenna 24 is an antenna provided at an exit (exit path) of a parking lot to communicate with a vehicle that exits from the parking lot. The parking lot server 2 can communicate with the in-vehicle device 10 mounted on a vehicle that exits from a parking lot via the communication module 23 and the antenna 24. When the parking lot server 2 is separate from a roadside device provided at a parking lot, the antenna 24 may be built in the roadside device. The communication module 23 is also connected to a plurality of vehicle sensors 25. The vehicle sensors 25 are sensors installed in respective ones of a plurality of parking compartments of a parking lot to detect the presence of a vehicle. The vehicle sensors 25 may be embedded underground, or may be built in poles etc. This allows the parking lot server 2 to recognize the vacancy status of the parking compartments.

The specific hardware configuration of the in-vehicle device 10 and the parking lot server 2 can be subjected to omission, replacement, and addition of constituent elements, as appropriate, depending on the embodiment. For example, the control unit may include a plurality of hardware processors. The hardware processors may be constituted by a microprocessor, an FPGA, a GPU, etc. The input/output device may be omitted, or an input/output device (e.g. an optical drive) other than those given as examples may be added. The in-vehicle device 10 and the parking lot server 2 may be constituted from a plurality of computers. In this case, the respective hardware configurations of the computers may or may not coincide with each other.

The configurations illustrated in FIGS. 2 and 3 are exemplary, and all or some of the functions illustrated may be executed using a specially designed circuit. The program may be stored and executed by a combination of the main storage device and the auxiliary storage device other than those illustrated.

### Software Configuration

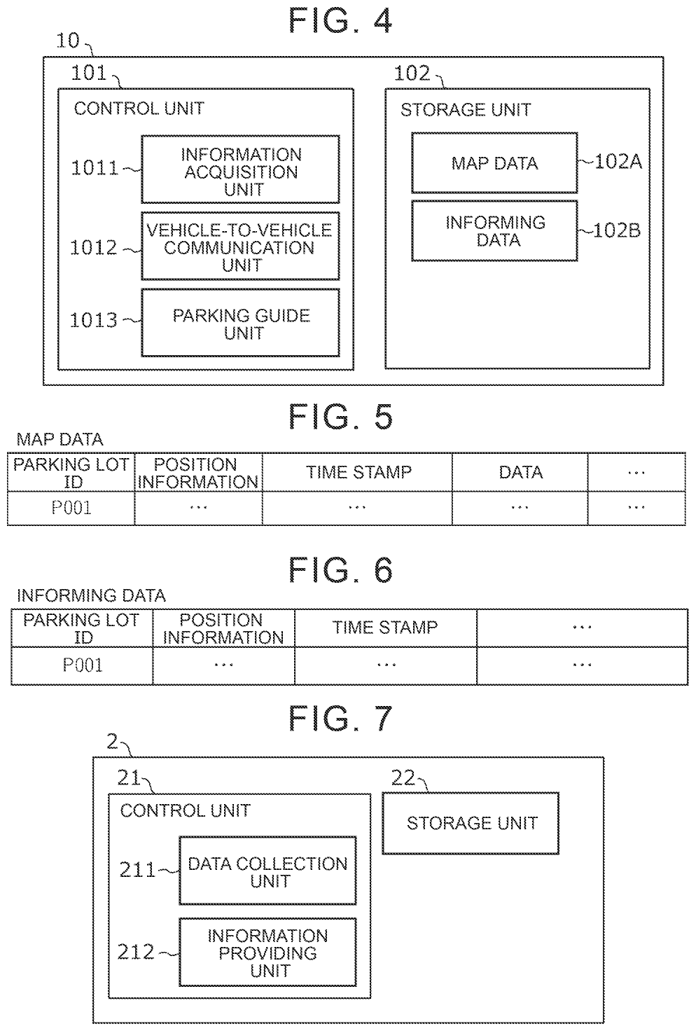

Next, the software configuration of devices that constitute the system will be described. FIG. 4 schematically illustrates the software configuration of the in-vehicle device 10 according to the present embodiment.

In the present embodiment, the control unit 101 is configured to include three software modules, namely an information acquisition unit 1011, a vehicle-to-vehicle communication unit 1012, and a parking guide unit 1013. The software modules may be implemented by the control unit 101 (CPU) executing the program stored in the storage unit 102. Information processing executed by the software modules is synonymous with information processing executed by the control unit 101 (CPU).

The information acquisition unit 1011 receives data (map data) about the vacancy status of a parking lot from the parking lot server 2. For example, the information acquisition unit 1011 receives map data transmitted from the antenna 24 installed at an exit from a parking lot via the wireless communication module 11, and stores the map data in the storage unit 102. That is, the information acquisition unit 1011 receives map data from the parking lot server 2 at the timing when the vehicle 1 exits from a predetermined parking lot. The stored map data are held until a predetermined period elapses.

The vehicle-to-vehicle communication unit 1012 exchanges data about the vacancy status of a parking lot by communicating with another vehicle 1. When the host vehicle is the first vehicle, that is, when the host vehicle is a vehicle that has exited from a parking lot within a predetermined period and that possesses map data, the vehicle-to-vehicle communication unit 1012 performs the following processes.
(1-1) Periodically broadcast informing data including the identifier of a parking lot corresponding to the possessed map data in the predetermined period
(1-2) Transmit the map data to a second vehicle in response to a request transmitted from the second vehicle.

When the host vehicle is the second vehicle, that is, when the host vehicle is a vehicle that has not exited from a parking lot within a predetermined period and that does not possess map data, the vehicle-to-vehicle communication unit 1012 performs the following processes.
(2-1) Receive informing data from the first vehicle and determine whether to request the first vehicle for map data
(2-2) Request the first vehicle to transmit map data and receive map data
(2-3) Execute a process related to entry into a parking lot based on the received map data
   The processes executed by the vehicle-to-vehicle communication unit 1012 will be discussed in detail later.

The parking guide unit 1013 determines whether to enter the parking lot based on the map data received from the first vehicle. The parking guide unit 1013 functions when the host vehicle is the second vehicle. For example, when the destination of the vehicle 1 is known and a parking lot corresponding to the received map data is located in the vicinity of the destination, the parking guide unit 1013 can determine to cause the host vehicle to enter the parking lot. The destination of the vehicle 1 and whether to enter the parking lot may be determined based on the result of interaction with the driver.

When entering the parking lot, the parking guide unit 1013 performs a predetermined process related to parking. For example, when the host vehicle is a vehicle driven by a driver, the parking guide unit 1013 may generate a graphical user interface (GUI) that provides guidance on the locations of the parking lot and the vehicle space based on the map data, and output the GUI via the input/output device 104. This enables assisting the driver. When the host vehicle is an autonomous driving vehicle, meanwhile, the parking guide unit 1013 may transmit the locations of the parking lot and the vehicle space to a device (e.g. an autonomous driving ECU) that controls travel of the vehicle. This enables the vehicle 1 to be autonomously parked.

In the present embodiment, the storage unit 102 stores map data 102A and informing data 102B. The map data 102A are map data received from the parking lot server 2, or map data received from the first vehicle.

FIG. 5 illustrates an example of the map data 102A. The map data include fields for an identifier (parking lot ID) of the parking lot, position information on the parking lot, a time stamp, and data. The parking lot ID field stores an identifier that uniquely identifies the parking lot managed by the system. The position information field stores information (e.g. a latitude and a longitude) about the position of the parking lot. The time stamp field stores the date and time when the first vehicle received the map data or the date and time when the map data were generated by the parking lot server 2. The time stamp can be considered as data that indicate the version of the map data.

The data field stores map data body (e.g. binary data). The map data may be data in which the geographical positions of a plurality of parking compartments in the parking lot and the vacancy status of the parking compartments are associated. The data field may store data to be provided to computers, or may store data (e.g. image data) to be provided to humans. It is not necessary that the map data should necessarily include the geographical positions of the parking compartments. The map data may represent only the number of remaining parking compartments available for parking, for example.

The informing data are data obtained by omitting an item about information on the vacancy of the parking lot from the map data. FIG. 6 illustrates an example of the informing data 102B. As illustrated in the drawing, the informing data are data obtained by omitting only the data field from the map data. The informing data are generated by the control unit 101 based on the map data.

FIG. 7 schematically illustrates the software configuration of the parking lot server 2 according to the present embodiment.

In the present embodiment, the control unit 21 of the parking lot server 2 is configured to include two software modules, namely a data collection unit 211 and an information providing unit 212. The software modules may be implemented by the control unit 21 (CPU) executing the program stored in the storage unit 22. Information processing executed by the software modules is synonymous with information processing executed by the control unit 21 (CPU).

The data collection unit 211 collects data from the vehicle sensors 25 provided in a parking lot covered by the host device, and generates map data based on such data. In the present embodiment, as described, the vehicle sensors 25 are disposed in the respective parking compartments, and the data collection unit 211 can generate map data based on data collected from the vehicle sensors 25. The data collection unit 211 may generate and update map data at predetermined timings (e.g. each time a vehicle enters and exits from the parking lot). The map data generated by the data collection unit 211 are temporarily stored in the storage unit 22.

The information providing unit 212 communicates with a vehicle that exits from a parking lot covered by the host device, and transmits the map data temporarily stored in the storage unit 22 to the vehicle (in-vehicle device 10). For example, when a vehicle sensor provided at an exit path detects a vehicle, the information providing unit 212 transmits the map data to the in-vehicle device 10 mounted on the vehicle via the antenna 24.

### Overview of Processes

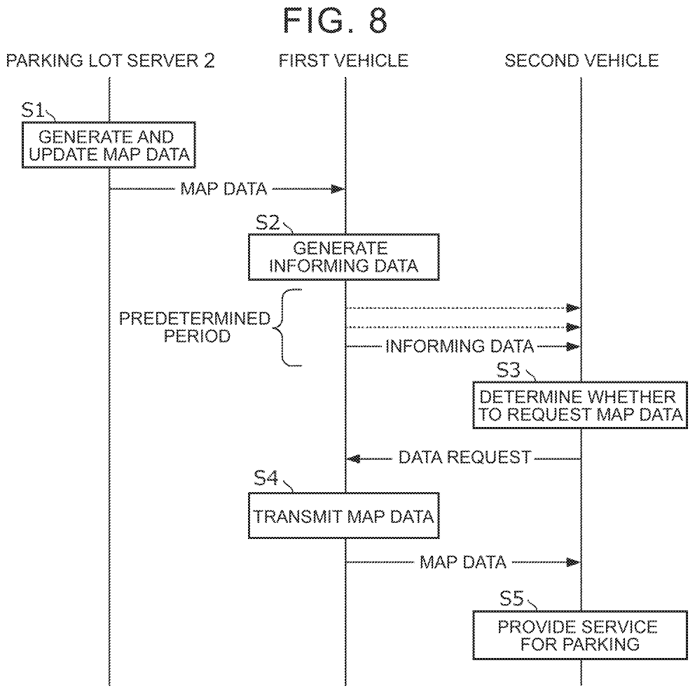

Next, an overview of processes executed by the parking lot server 2 and the in-vehicle device 10 will be described with reference to FIG. 8. FIG. 8 is a sequence diagram of processes executed by the parking lot server 2, the first vehicle, and the second vehicle. Here, it is assumed that the first vehicle is a vehicle that exits from a parking lot managed by the parking lot server 2, and that the second vehicle is a vehicle (e.g. a vehicle that passes the first vehicle on a road) positioned in the vicinity of the first vehicle.

First, in step S1, the parking lot server 2 generates or updates map data. In this step S1, the data collection unit 211 collects data from the vehicle sensors 25, and generates map data based on the collected data. When map data are already generated, the data collection unit 211 may update the content of the map data. Then, the information providing unit 212 transmits the map data to a vehicle (first vehicle) that exits from the parking lot. The map data are received by the in-vehicle device 10 (information acquisition unit 1011) mounted on the first vehicle, and stored.

In step S2, the in-vehicle device 10 (vehicle-to-vehicle communication unit 1012) mounted on the first vehicle generates informing data based on the map data. The generated informing data are broadcast for a predetermined period by the vehicle-to-vehicle communication unit 1012. The predetermined period can be defined as “until a predetermined time (e.g. 5 minutes) elapses after exiting from a parking lot” or “until a predetermined distance (e.g. 1 kilometer) is traveled after exiting from a parking lot”, for example. The informing data may be transmitted periodically at predetermined intervals. The predetermined period may be defined by the number of times when the informing data are transmitted.

In step S3, the second vehicle that has received the informing data determines whether to request the first vehicle for map data. For example, the second vehicle may determine to request the first vehicle to transmit map data when the second vehicle does not have information about the parking lot indicated by the informing data.

When the second vehicle has determined to request the first vehicle to transmit map data, the vehicle-to-vehicle communication unit 1012 of the second vehicle transmits a transmission request (hereinafter a data request) for map data to the first vehicle through vehicle-to-vehicle communication. The data request may include the identifier of the parking lot and the time stamp corresponding to the informing data. That is, the data request may include information that identifies map data on what parking lot to request and map data of what version to request. The vehicle-to-vehicle communication unit 1012 of the first vehicle transmits corresponding map data to the second vehicle through vehicle-to-vehicle communication in response to the data request. The second vehicle provides a service for parking based on the received map data (step S5).

### Flowchart

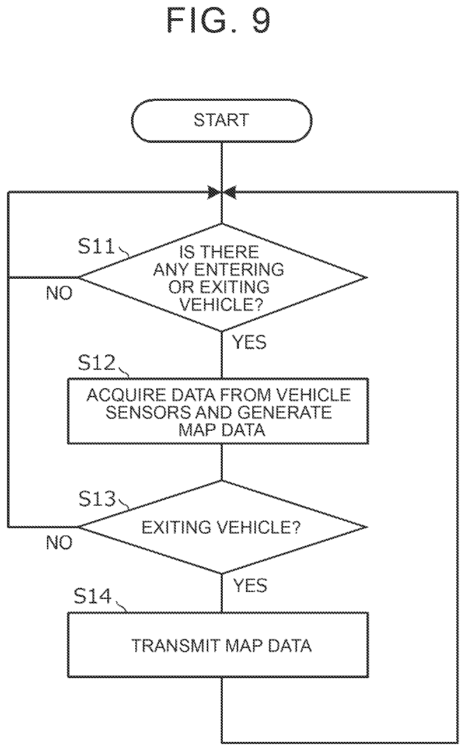

Next, specific contents of the processes performed by the parking lot server 2 and the in-vehicle device 10 will be described. FIG. 9 is a flowchart of the process executed by the parking lot server 2.

First, in step S11, the data collection unit 211 determines that there is any vehicle that has entered or exited from a parking lot covered by the host device (i.e. the number of vehicles parked has varied). The presence or absence of entry and exit may be determined based on information acquired from the vehicle sensors provided at entry and exit paths of the parking lot or a parking lot device (such as a vehicle gate). It may be determined that entry into or exit from a parking lot has occurred when the detection results from the vehicle sensors 25 have varied. When there is a vehicle that has entered or exited from the target parking lot, the process transitions to step S12. When there is no vehicle that has entered or exited from the parking lot, the process returns to step S11.

In step S12, the data collection unit 211 acquires data (i.e. the presence or absence of a vehicle in each parking compartment) from the vehicle sensors 25, and generates map data. The generated map data are temporarily stored in the storage unit 22. Next, in step S13, the information providing unit 212 determines whether the vehicle determined in step S11 is a vehicle that exits from the parking lot. The presence of a vehicle that exits from the parking lot can be detected by a vehicle sensor provided at the exit path, for example. When the vehicle determined in step S11 is a vehicle that exits from the parking lot, the process transitions to step S14. When the vehicle determined in step S11 is not a vehicle that exits from the parking lot, the process returns to step S11. In step S14, the information providing unit 212 transmits map data to the in-vehicle device 10 of the vehicle that exits from the parking lot via the antenna 24 provided at the exit path.

While the processes in steps S13 and S14 are described separately in the present example, the two steps may be integrated with each other. For example, when communication with the in-vehicle device 10 is established via the antenna 24 provided at the exit path, it may be determined that there is a vehicle that exits from the parking lot, and subsequently map data may be transmitted.

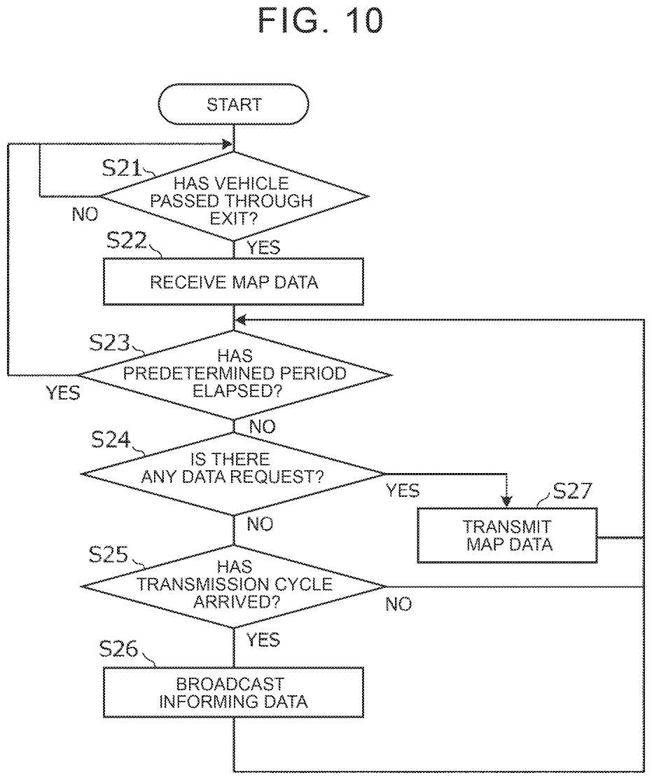

Next, a process executed by the first vehicle that exits from a parking lot will be described. FIG. 10 is a flowchart of a process executed by the in-vehicle device 10 mounted on the first vehicle that exits from a parking lot. The illustrated process is repeatedly executed during travel of the first vehicle.

First, in step S21, the information acquisition unit 1011 determines whether the host vehicle has passed through an exit from a predetermined parking lot. The predetermined parking lot refers to a parking lot for which map data are provided. In the present step, it may be determined that the vehicle has passed through an exit from the predetermined parking lot when the wireless communication module 11 has received a beacon signal transmitted via the antenna 24 installed at an exit path of the parking lot, for example. When a positive determination is made in the present step, the process transitions to step S22. When a negative determination is made in the present step, the process in step S21 is repeatedly performed.

In step S22, the information acquisition unit 1011 receives the map data transmitted from the parking lot server 2 via the antenna 24. The received map data are temporarily stored in the storage unit 102. Next, in step S23, the vehicle-to-vehicle communication unit 1012 determines whether a predetermined period has elapsed since the first vehicle exited from the parking lot. As discussed earlier, the predetermined period may be defined according to the time since the first vehicle exited from the parking lot, the distance traveled since the first vehicle exited from the parking lot, etc. Therefore, the vehicle-to-vehicle communication unit 1012 may acquire data about the travel time, the travel distance, etc. from the ECU of the vehicle 1 etc.

Here, when the predetermined period has elapsed, the process returns to step S21. In this case, the temporarily stored map data are deleted. When the predetermined period has not elapsed, the process proceeds to step S24.

In step S24, the vehicle-to-vehicle communication unit 1012 determines whether a data request has been received from the second vehicle. Here, when a data request has not been received from the second vehicle, the process transitions to step S25. When a data request has been received from the second vehicle, the process transitions to step S27 (as discussed later).

In step S25, the vehicle-to-vehicle communication unit 1012 determines whether the transmission cycle of informing data has arrived. When the transmission cycle of informing data (e.g. every second) has arrived, the process transitions to step S26. When the transmission cycle of informing data has not arrived, the process returns to step S23.

In step S26, the vehicle-to-vehicle communication unit 1012 generates informing data based on the map data, and broadcasts the generated informing data to a surrounding vehicle (second vehicle) via the wireless communication module 11. After that, the process returns to step S23.

When a data request has been received from the second vehicle in step S24, the process transitions to step S27, and the vehicle-to-vehicle communication unit 1012 transmits map data to the in-vehicle device 10 mounted on the second vehicle that made a request for map data. After that, the process returns to step S23.

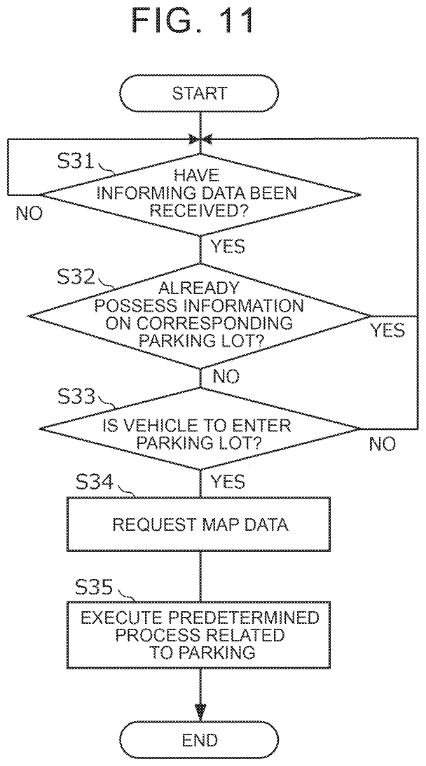

Next, a process executed by the second vehicle to acquire map data by performing vehicle-to-vehicle communication with the first vehicle will be described. FIG. 11 is a flowchart of a process executed by the in-vehicle device 10 mounted on the second vehicle. The illustrated process is repeatedly executed during travel of the second vehicle.

First, in step S31, the vehicle-to-vehicle communication unit 1012 determines whether the informing data broadcast by the first vehicle have been received. Here, when the informing data broadcast by the first vehicle have been received, the process transitions to step S32. When the informing data have not been received, the process in step S31 is repeatedly performed.

In step S32, the vehicle-to-vehicle communication unit 1012 determines whether the host vehicle already possesses information about the parking lot indicated by the informing data. When the host vehicle already possesses information about the parking lot indicated by the informing data, a positive determination is made, and the process returns to step S31. For example, a positive determination is made in the present step when map data on the relevant parking lot were received from the first vehicle within a predetermined period in the past. When a negative determination is made in step S32, the process transitions to step S33.

In step S33, the vehicle-to-vehicle communication unit 1012 determines whether the vehicle is to enter the parking lot indicated by the informing data. For example, a positive determination is made in the present step when the host vehicle is traveling in the direction toward the parking lot and the destination of the host vehicle is located in the vicinity of the parking lot. The position information and the advancing direction of the host vehicle can be determined based on information acquired from the GPS module 105. When the in-vehicle device 10 has a navigation function, information about the destination of the host vehicle may be acquired from a module etc. that provides the navigation function. It may be determined whether the vehicle is to enter the parking lot using other information. For example, it may be determined whether the vehicle is to enter the parking lot based on a matter such as “whether the destination of the host vehicle is equipped with a parking lot” or “whether the time stamp of the informing data is later than a predetermined time”. When a positive determination is made in step S33, the process transitions to step S34. When a negative determination is made in step S33, the process returns to step S31.

In step S34, the vehicle-to-vehicle communication unit 1012 transmits a data request to the first vehicle, that is, the vehicle that transmitted the informing data. In response to this, the first vehicle transmits map data.

In step S35, the parking guide unit 1013 executes a predetermined process related to parking based on the received map data. For example, when a driver is on the second vehicle, the parking guide unit 1013 may generate a graphical user interface (GUI) that provides guidance on the locations of the parking lot and the vehicle space based on the received map data, and output the GUI. When the second vehicle is an autonomous driving vehicle, meanwhile, the parking guide unit 1013 may transmit the locations of the parking lot and the vehicle space to a device (e.g. an autonomous driving ECU) that controls travel of the vehicle.

In the system according to the present embodiment, as described above, the first vehicle that has exited from a predetermined parking lot acquires data about the vacancy status the parking lot, and informs the second vehicle of the vacancy status of the parking lot by performing vehicle-to-vehicle communication. Since such operation is performed until a predetermined period elapses after the first vehicle exits from the parking lot, it is possible to appropriately notify the second vehicle as a candidate to enter the parking lot of the vacancy status of the parking lot.

### Second Embodiment

In the first embodiment, as described in relation to step S32, the second vehicle transmits a data request to the first vehicle when the second vehicle does not have information on the parking lot indicated by the informing data. In the second embodiment, in contrast, it is determined whether to request the first vehicle to transmit map data according to a combination of a plurality of conditions.

For example, reception of map data may be useless when the second vehicle is traveling in the same direction as the first vehicle and when the destination of the second vehicle is not close to the parking lot indicated by the informing data. Thus, in the present embodiment, it is determined that the second vehicle requests the first vehicle for map data when the following conditions are met.
(A) When the second vehicle does not have information about the parking lot indicated by the informing data
(B) When the second vehicle is traveling in the direction toward the parking lot indicated by the informing data
(C) When the destination of the host vehicle is located in the vicinity of the parking lot indicated by the informing data
(D) When the time stamp of the informing data is later than a predetermined time

The second vehicle may determine whether to request the first vehicle to transmit map data according to a combination of the above conditions. Alternatively, the first vehicle may be requested to transmit map data when any of the above conditions is met. For example, the second vehicle may transmit a data request again in order to receive map data again when it is determined that there are map data with a later time stamp, even when map data on a certain parking lot have already been received.

### MODIFICATIONS

The above embodiments are merely exemplary, and the present disclosure may be modified as appropriate without departing from the gist of the present disclosure. For example, the processes and the units described in relation to the present disclosure can be implemented in any combination unless any technical contradiction occurs.

While the parking lot server 2 detects a vehicle that exits from a parking lot and transmits map data to the vehicle through unicasting in the description of the embodiments, other methods may be used as long as map data can be delivered to a vehicle that exits from a parking lot. For example, the parking lot server 2 may periodically broadcast the latest map data via the antenna 24 located in the vicinity of an exit from a parking lot. In this case, a vehicle that has received the map data may start behaving as the first vehicle when it is detected that the vehicle has exited from the parking lot.

While the second vehicle receives map data from the first vehicle only once in the description of the embodiments, map data may be transmitted and received a plurality of times. In this case, the condition for the determination in step S32 may be changed to “whether the second vehicle already possesses the latest information on the parking lot indicated by the informing data”. For example, the second vehicle may be able to receive map data on a certain parking lot from a certain vehicle and thereafter receive map data on the same parking lot of a later version from a different vehicle.

While the first vehicle transmits map data to the second vehicle in response to the second vehicle transmitting a data request in the description of the embodiments, transmission of map data from the first vehicle to the second vehicle may be implemented by other methods. For example, the first vehicle may form a group (cluster) of vehicles that share map data. In this case, the second vehicle may send an application for partition in the cluster to the first vehicle, instead of transmitting a data request, and the first vehicle may accept such an application. The first vehicle may distribute map data to vehicles that belong to the cluster. The cluster may be maintained as long as the vehicles are positioned in the vicinity of each other.

A process described as being performed by a single device may be executed in a distributed manner by a plurality of devices. Alternatively, processes described as being performed by different devices may be executed by a single device. It is possible to flexibly change what hardware configuration (server configuration) implements functions of a computer system.

The present disclosure can also be implemented by supplying a computer with a computer program that implements the functions described in relation to the above embodiments and causing one or more processors of the computer to read and execute the program. Such a computer program may be provided to the computer using a non-transitory computer-readable storage medium that is connectable to a system bus of the computer, or may be provided to the computer via a network. Examples of the non-transitory computer-readable storage medium include any type of disk such as a magnetic disk (such as a floppy (registered trademark) disk and a hard disk drive (HDD)) and an optical disk (such as a Compact Disc Read Only Memory (CD-ROM), a Digital Versatile Disc (DVD), and a Blu-ray Disc), a ROM, a RAM, an EPROM, an electrically erasable programmable read only memory (EEPROM), a magnetic card, a flash memory, an optical card, and any type of medium that is suitable to store electronic instructions.

What is claimed is:

1. An information processing method comprising:
acquiring first data about a vacancy status of a first parking lot by a first vehicle when exiting from the first parking lot;
broadcasting second data including an identifier of the first parking lot by the first vehicle having exited from the first parking lot; and
transmitting, in response to a request transmitted from a second vehicle having received the second data, the first data to the second vehicle by the first vehicle.

2. The information processing method according to claim 1, wherein the second vehicle determines whether to request the first vehicle to transmit the first data based on at least the identifier of the parking lot included in the second data.

3. The information processing method according to claim 2, wherein the second vehicle requests the first vehicle to transmit the first data when the first parking lot meets a predetermined condition.

4. The information processing method according to claim 3, wherein the predetermined condition is met when the second vehicle does not have information about the vacancy status of the first parking lot.

5. The information processing method according to claim 3, wherein the predetermined condition is met when the second vehicle does not have information about the vacancy status of the first parking lot generated after a predetermined timing.

6. The information processing method according to claim 1, wherein the first data include a map that indicates the vacancy status of the first parking lot.

7. The information processing method according to claim 6, wherein the second vehicle performs parking control for the vehicle based on the first data received from the first vehicle.

8. The information processing method according to claim 6, wherein the second vehicle provides a driver with guidance on a parking compartment based on the first data received from the first vehicle.

9. The information processing method according to claim 1, wherein the first vehicle broadcasts the second data at predetermined time intervals until a predetermined period elapses after the first vehicle exits from the first parking lot.

10. The information processing method according to claim 9, wherein the predetermined period is determined based on a distance traveled by the first vehicle after exiting from the first parking lot.

11. The information processing method according to claim 9, wherein the predetermined period is determined based on an elapsed time since the first vehicle exits from the first parking lot.

12. A non-transitory storage medium storing a program causing a computer to execute the information processing method according to claim 1.

13. An information processing device associated with a first vehicle, comprising a control unit configured to:
acquire first data about a vacancy status of a first parking lot when the first vehicle exits from the first parking lot;
broadcast second data including an identifier of the first parking lot via a communication device mounted on the first vehicle; and
transmit, in response to a request transmitted from a second vehicle having received the second data, the first data to the second vehicle.

14. The information processing device according to claim 13, wherein the control unit is configured to receive the first data from a server device associated with the first parking lot.

15. The information processing device according to claim 14, wherein the first data include a map that indicates the vacancy status of the first parking lot.

16. The information processing device according to claim 13, wherein the control unit is configured to broadcast the second data at predetermined time intervals until a predetermined period elapses after the first vehicle exits from the first parking lot.

17. The information processing device according to claim 16, wherein the predetermined period is determined based on a distance traveled by the first vehicle after exiting from the first parking lot.

18. The information processing device according to claim 16, wherein the predetermined period is determined based on an elapsed time since the first vehicle exits from the first parking lot.
